(19) United States
(12) Patent Application Publication
(10) Pub. No.: US 2023/0192315 A1
(43) Pub. Date: Jun. 22, 2023

(54) LIGHTING DEVICE FOR AN AIRPORT RUNWAY

(71) Applicants: Björn Abel, Zurich (ES); Klaus Aures, Lippstadt (DE); Jordina Petrol, Sant Fellu Llobregat (ES)

(72) Inventors: Björn Abel, Zurich (ES); Klaus Aures, Lippstadt (DE); Jordina Petrol, Sant Fellu Llobregat (ES)

(21) Appl. No.: 13/642,793

(22) PCT Filed: Apr. 11, 2011
(86) PCT No.: PCT/EP2011/056087

§ 371 Date: Oct. 22, 2012

(30) Foreign Application Priority Data
Apr. 22, 2010 (DE) 10 2010 018 178.1

(51) Int. Cl. B64F 1/20; F21V 15/01; F21V 17/10; F21V 7/10

(52) U.S. Cl. CPC B64F 1/205; F21V 15/01; F21V 17/10; F21V 7/10; F21W 2111/06

(57) ABSTRACT

A lighting device for an airport runway with a base carrier, at which at least one lighting unit is fastened, with the lighting unit comprising a light source, a reflector, and a covering glass panel, with the light source and the reflector being combined to a joint lighting module, with the light source and the reflector being assembled on a joint carrier of the lighting module connected to the base carrier in a detachable fashion.

The invention relates to a lighting device for an airport runway with a base carrier, at which at least one lighting unit is fastened, with the lighting unit comprising a light source, a reflector, and a covering glass panel.

A lighting device for an airport runway is known from DE 40 08 932 A1 which comprises a disk-shaped base carrier covering a cavity of the runway, in which one or more lighting units are arranged aligned in the same direction or in two directions. The lighting units show a smaller diameter than the base carrier and are connected thereto in a detachable fashion via a screw connection. The lighting units each show a light source, a reflector, a mirror placed in front of the reflector, as well as a covering glass panel. The glass panel is embodied as a lens, essentially arranged above the reflector. The lighting unit therefore shows a relatively large extension perpendicularly in reference to the base carrier and thus extends downwards to a large extent. The lighting unit comprises a housing provided with cooling ribs, which is connected in a detachable fashion via a screw connection to a front rim partially covering a glass panel. In the event a component thereof should be exchanged due to damages to the lighting unit, not only must the lighting unit be separated from the base carrier but also the front rim from the housing.

The objective of the present invention is therefore to further develop a lighting device for an airport runway and a lighting module such that on the one hand a lighting unit integrated in the lighting device shows a compact design and on the other hand the interchangeability of the components of the lighting unit is simplified.

In order to attain this objective the invention, in connection with the preamble of claim 1, is characterized in that the light source and the reflector are combined to a joint lighting module, with the light source and the reflector being assembled on a joint carrier of the lighting module, connected to the base carrier in a detachable fashion.

According to the invention, a relatively flat and compact lighting module is formed with a carrier, on which all components technically relevant for lighting are assembled. Only this carrier of the lighting module is connected to the base carrier in a detachable fashion so that the module can be exchanged for maintenance relatively quickly. The technical components for lighting, such as particularly a light source and a reflector, can be easily removed from the carrier, which reduces the expenses for repair. Due to the fact that the technical components for lighting are arranged on a joint carrier the lighting module may be designed relatively flat.

According to a preferred embodiment of the invention a glass panel, placed in front of the reflector in the direction of light emission, is arranged in an area of the base carrier adjacent to the lighting module and/or the carrier of the lighting module. Advantageously here the lighting module can be embodied in a relatively flat and compact fashion.

According to a further development of the invention the carrier of the lighting module is embodied as a triangular body, which with a bottom contacts a flat side of the base carrier and which shows a diagonal area, on which preferably the light source and the reflector are fastened side-by-side. The technical components for lighting, such as the light source and the reflector, are therefore located preferably inside or above a recess of the base carrier. For repair purposes good accessibility of the lighting device from the top is provided, wherein perhaps the technical components for lighting can be individually exchanged. The angle of the diagonal area in reference to the direction of extension of the base carrier influences the primary direction of emission of the light source. This way, advantageously the primary direction of emission of the lighting unit can be adjusted.

According to a further development of the invention the carrier of the lighting module is connected at one of its edges to the base carrier in a force-fitting and/or form-fitting fashion. Alternatively the carrier of the lighting module can also be connected to the base carrier at the edge or over the entire area in a material-to-material fashion. Advantageously, the carriers of the lighting module can be exchanged easily by the force-fitting and/or form-fitting connection.

According to a first embodiment of the invention the base carrier is embodied as a cover panel covering a cavity of the runway, wherein the carrier of the lighting module can be fastened at the bottom thereof. Here, the base carrier shows an opening through which the lighting module with its technical components for lighting can be guided in the assembled position and positioned only by fastening the carrier of the lighting module at the base carrier. Advantageously the lighting device shows a relatively flat design by this measure, because the lighting module is essentially located inside the cover panel.

According to a second embodiment of the invention the base carrier is embodied as a housing plate extending in the cavity of the runway, with a carrier of the lighting module being fastened at its top. A bottom of the housing plate may serve to form a cooling body with cooling ribs, so that improved heat dissipation is given.

According to a further development of the invention the light source is embodied as an LED light element and/or as a multi-chip light element. This way, the lighting unit shows a relatively space-saving design.

In order to attain the objective the invention comprises a lighting module according to the features of claim 10.

Advantageously the lighting module according to the invention allows a compact and maintenance-friendly design of the lighting device.

In the following, exemplary embodiments of the invention are explained in greater detail using the drawings.

It shows:

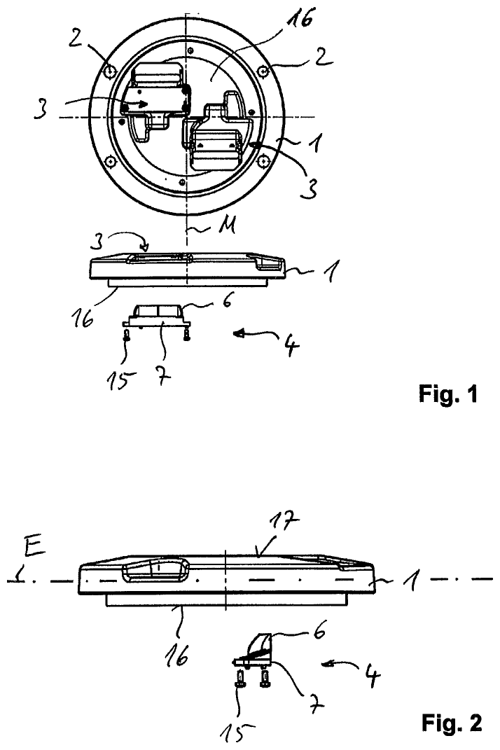

FIG. 1 a bottom and a top view of a base carrier with two recesses for accepting one lighting module for two lighting units each according to a first embodiment,

FIG. 2 a side view of the base carrier according to claim 1, shown off-set by 90°,

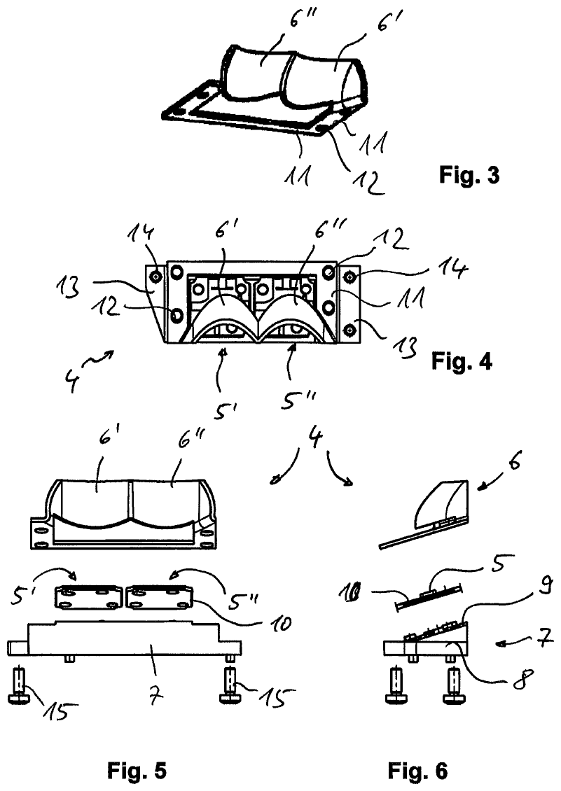

FIG. 3 a perspective illustration of a dual-reflector of the lighting module inserted in the recess of the base carrier,

FIG. 4 a top view of the lighting module,

FIG. 5 an exploded illustration of the lighting module seen from a longitudinal side,

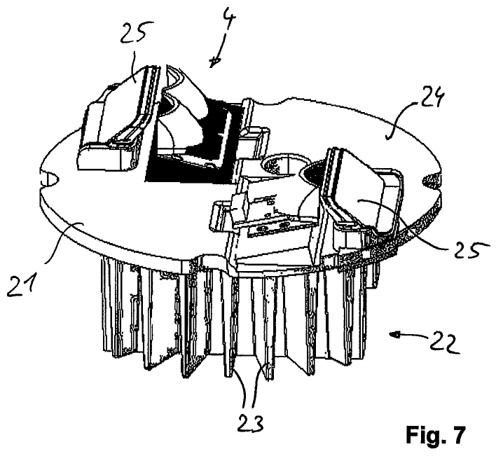

FIG. 6 an exploded illustration of the lighting module seen from a narrow side, and

FIG. 7 a perspective illustration of a lighting device according to a second embodiment with a base carrier, showing a cooling body at the bottom.

A lighting device according to the invention can preferably be used in airports, in order to serve as lighting for runways or the tarmac.

According to a first embodiment of the invention according to FIGS. 1 through 6 the lighting device shows a disk-shaped base carrier 1, which covers a cavity of the runway as a cover panel. For the screw-fastening of the base carrier 1 at a floor, not shown, the base carrier 1 shows bores 2 at the edges. The base carrier 1 further shows a recess 3 at both sides of a lateral central level M to accept a lighting module 4. The recesses 3 are embodied such that essentially lighting modules 4 with identical dimensions can be inserted, which emit light in two different directions.

The lighting module 4 comprises a light source 5 as well as a reflector 6, each of which are respectively assembled on a joint lighting module carrier 7 of the lighting module 4. The lighting module carrier 7 is embodied as a triangular body showing on the one hand a base area 8, extending in the assembled position in an extension level E of the base carrier 1. Further, the lighting module carrier 7 shows a diagonal area 9 extending in an acute angle in reference to the base area 8, on which a circuit board 13 equipped with a light source 5 is fastened.

The light source 5 is embodied as a multi-chip LED lighting element, wherein for example three LED-chips 5 may be arranged on the circuit board 10. In the present exemplary embodiment the reflector 6 is embodied as a dual chamber reflector, with a first LED-lighting element 5″ being allocated to a first reflector chamber 6′ and a second LED-lighting element 5″ to a second reflector chamber 6″. The dual chamber reflector 6 comprises, in addition to the reflector areas 6′, 6″, additionally a fastening frame 11, provided with bores 12, so that the dual chamber reflector 6 can be fastened, for example by a screw connection, to the diagonal area 9 in a force-fitting fashion.

For example, the circuit boards 10 may be fastened to the diagonal area 9 in a form-fitting or force-fitting fashion.

An angle between the diagonal area 9 and the base area 8 is sized such that the light emitted by the light sources 5′, 5″, after reflection at the reflector areas of the reflector chambers 6′, 6″, is emitted to the environment at a predetermined angle.

At opposite facial sides of the lighting module carrier 7, laterally projecting fastening lips 13 are provided with bores 14 for a force-fitting connection of the lighting module carrier 7 to the base carrier 1. In the present exemplary embodiment three bores 14 are provided, so that a screw connection to the base carrier 1 can occur, using three screws 15. The lighting module carrier 7 can be fixed at a bottom 16 of the base carrier 1.

As discernible from FIG. 4, the fastening of the lighting module carrier 7 occurs at the base carrier 1 and the fastening of the reflector 6 at the lighting module carrier 7 in a projection to the level of extension E side-by-side, so that for example the reflector 6 is accessible and interchangeable from the top without here requiring that the lighting module 4 is detached from the base carrier 1.

According to an alternative embodiment, not shown, the lighting module carrier 7 may also be connected to the base carrier 1 in a form-fitting manner or by material-to-material connection.

Advantageously the lighting module carrier 7 is connected to the base carrier 1 only at an edge of the carrier in a detachable fashion.

Due to the fact that the lighting module carrier 7 is arranged circumferential in the recess 3 of the base carrier 1 it is capable of dissipating the heat generated by the light sources 5 into the base carrier 1.

A glass panel (not shown) is fastened at the top 17 of the base carrier 1, embodied as a prism-shaped glass panel, and the light beam deflected by the reflector 6 passes through it to the environment. The glass panel is arranged in an area of the base carrier 1 adjacent to the lighting module 4. They are arranged at the same elevation as the reflectors 6 so that the lighting device does not extend any further upwards. The glass panel and the lighting module 4 are therefore at the same elevation range as the base carrier 1. Therefore together with the lighting module 4 the glass panel forms a lighting unit.

As shown in a second embodiment of the invention according to FIG. 7, a base carrier 21 of the lighting device is embodied as a housing plate extending into the cavity of the runway, with a cooling body 22 with cooling ribs 23 following at its bottom. At a top 24 of the base carrier 21 the lighting module 4 according to the first exemplary embodiment is fastened via screw connections. Unlike the first embodiment, the lighting module 4 is not fastened from the bottom, here, but from the top on the base carrier 21. A glass panel 25 is arranged in an area of the base carrier 21 adjacent to the lighting module 4 through which light emitted by the lighting module 4 passes into the environment. Together with the lighting module 4 the glass panel 25 forms the lighting unit. Similar to the first embodiment, the lighting module 4 and the glass panel 25 are located on a joint flat side of the base carrier 21, in this case the top 24.

The base carrier 21 is preferably formed from an aluminum material.

Based on a first embodiment of the invention according to claims 1 through 6 the glass panel is inserted with a preferably interchangeable, circumferential gasket in the base carrier 1 and then, by the assembly of the lighting module 4, fixated tightly in its position. By the screw connection of the lighting module 4 at the base carrier 1 the lighting module 4 is pressed into the gasket. The glass panel as well as the gasket, similar to the lighting module 4, can be placed in a respectively embodied recess at the bottom 16 of the base carrier 1. This way, a simple exchange of the glass panel can occur without requiring any tools.

### LIST OF REFERENCE CHARACTERS

1 base carrier
2 bores
3 recesses
4 lighting module
5, 5′, 5″ light source
6, 6′, 6″ reflector
7 lighting module carrier
8 base area
9 diagonal areas
10 circuit board
11 fastening frame
12 bores
13 fastening lips
14 bores
15
16 bottom
17 top
22 base carrier
23 cooling ribs
24 top
25 glass panel
M lateral central level
E level of extension

1. A lighting device for an airport runway with a base carrier, at which at least one lighting unit is fastened, with the lighting unit comprising a light source, a reflector, and a covering glass panel, wherein the light source and the reflector are combined to form a joint lighting module, with the light source and the reflector being assembled on a joint carrier of the lighting module, connected to the base carrier in a detachable fashion.

2. The lighting device according to claim 1, further comprising a glass panel is fastened at the base carrier in an area adjacent to the lighting module.

3. The lighting device according to claim 4, wherein the lighting module and the glass panel are arranged on a joint flat side of the base carrier.

4. A The lighting device according to claim 1, wherein the joint carrier of the lighting module is connected in a force-fitting or form-fitting manner to an edge of the panel.

5. The lighting device according to claim 1, wherein the base carrier is formed as a cover disk covering a cavity of the runway, wherein the lighting module can be fixed at the bottom of the joint carrier.

6. The lighting device according to claim 1, wherein the base carrier is embodied as a housing plate extending in a cavity of the runway, with the joint carrier of the lighting module and the glass panel being fixed at its bottom, and that a cooling body follows at the bottom of the housing plate.

7. The lighting device according to claim 1, wherein the light source is an LED light element or as a multi-chip LED light element and that the reflector is embodied as a single- or multi-chamber reflector, with one light source respectively being allocated to each reflector chamber.

8. The lighting device according to claim 2, wherein the glass panel is formed as a glass plate.

9. The lighting device according to claim 2, wherein the glass panel can be inserted via a gasket in a recess of the base carrier and by fixating the lighting module it is impressed at the base carrier in the inserted position.

10. A lighting module for a lighting device, comprising at least one light source and at least one reflector being arranged on a joint carrier.

11. The lighting device according to claim 1, wherein the joint carrier of the lighting module is connected in a material-to-material manner to the base carrier.
